(19) United States
(12) Patent Application Publication
(10) Pub. No.: US 2006/0012699 A1
(43) Pub. Date: Jan. 19, 2006

(54) Digital still camera, a digital still camera built-in mobile phone, and an image stabilizing method of the digital still camera

(76) Inventor: Yasuhiro Miki, Daito-shi (JP)

Correspondence Address: SNELL & WILMER L.L.P., 600 ANTON BOULEVARD, SUITE 1400, COSTA MESA, CA, 92626, US

(21) Appl. No.: 11/155,994

(22) Filed: Jun. 17, 2005

(30) Foreign Application Priority Data
Jun. 21, 2004 (JP) 2004-182935

(51) Int. Cl. H04N 5/222

(52) U.S. Cl. 348/333.01

(57) ABSTRACT

The present invention offers a digital still camera capable of simply preventing blurring due to hand shake caused by holding down the shutter button of the digital still camera. When auto focus mode is in operation, the image capture unit 102 captures images of a subject after receiving directions from the control unit 105 to capture the images at predetermined time intervals, and outputs the image data to the control unit 105. The control unit 105 sequentially stores, in the buffer 103, the image data input from the image capture unit 102, and displays the images in the display unit 104. The control unit 105 reads image data stored most recently in the buffer 103 when a user operation of holding down the shutter button in the operation unit 101 is detected, and displays the image data in the display unit 104 while storing the image data in the image storage unit 106. This allows to store image data captured right beforehand shake due to the operation of holding down the shutter button is made.

### BACKGROUND OF THE INVENTION

1. Field of the Invention

The present invention relates to a digital still camera, in particular to a technology for easily preventing hand shake made when the shutter button of a digital still camera is held down.

2. Description of the Related Art

Digital still cameras have gained in popularity immensely in recent years with an increase in resolution, which enables everyone to readily enjoy shooting. However, when beginners capture images, hand shake made when the shutter button is held down often becomes a problem.

If captured with hand shake, images are blurring when displayed.

A number of image stabilizing mechanisms have been proposed to eliminate blurring. One of the examples is discussed in Japanese Laid-Open Patent Application Publication No. H5-134287.

However, to eliminate blurring, it is necessary to predict the amount of shaking and make compensation to thereby set the amount of shaking to “0” by using a complex mechanism.

### SUMMARY OF THE INVENTION

The object of the present invention is to offer a digital still camera preventing hand shake and producing images free from blurring without providing a complex mechanism. In addition, the image stabilizing mechanism of the digital still camera of the present invention is distinctly simple, and can therefore be easily applied to a digital still camera built in a mobile phone.

The above-stated object is achieved by a digital still camera comprising: an operation unit operable to receive operations from the user; a detection unit operable to detect the operations; an image capture unit operable to capture image data pieces of a subject at a predetermined time interval when the detection unit detects a predefined operation; a buffer operable to store therein the image data pieces captured by the image capture unit in order of being captured; a display unit operable to display the image data pieces stored in the buffer; and a control unit operable to cause the display unit to display, from among the image data pieces stored in the buffer, the most recently stored piece when the detection unit detects an operation of holding down a shutter button.

With such a structure, the present invention is capable of displaying a clear and sharp image free from blurring because, even if a blurring image is produced with hand shake caused when the user holds down the shutter button, it displays image data captured right before the shutter button is held down.

Here, the minimum length of the predetermined time interval may be defined as the sum of (i) time required to store each piece of the image data pieces captured by the image capture unit into the buffer and (ii) time required to read the piece from the buffer and display the read piece in the display unit.

With such a structure, the present invention is capable of preparing in advance image data free from blurring with hand shake associated with holding down the shutter button.

The digital still camera may further comprise: an image data storage unit operable to store therein image data pieces. Here, the predefined operation is to set for auto focus mode. When the detection unit detects the operation of holding down the shutter button, the control unit reads the most recently stored piece displayed by the display unit and causes the image data storage unit to store therein the read most recently stored piece.

With such a structure, the present invention is capable of providing image data corresponding to holding down the shutter button by using, for example, the auto focus mode set by holding down the shutter button halfway as a trigger.

The digital still camera may further comprise: a motion detection unit operable to detect a motion of a body of the digital still camera. Here, the predefined operation is to turn on a power supply for starting to capture the image data pieces. If the motion detection unit detects the motion which is equal to or greater than a predetermined value at a moment when the detection unit receiving power supply in advance detects the operation of holding down the shutter button, the control unit causes the display unit to display the most recently stored piece.

With such a structure, the present invention is capable of starting image capture by using the power supply of the digital still camera being turned on as a trigger, and using image data captured right before holding down the shutter button as image data for holding down the shutter button when the motion equal to or greater than the predetermined value is detected by the motion detection unit.

Here, the predetermined value may be a value at which the image data pieces captured by the image capture unit become blurred from movements of the digital still camera due to hand shake.

With such a structure, the present invention is capable of producing clear and sharp image data free from blurring caused by hand shake.

The buffer may include: a 1st buffer used by the control unit to store therein the image data pieces captured by the image capture unit while sequentially updating; and a 2nd buffer used by the control unit, instead of the 1st buffer, to store therein the image data pieces captured by the image capture unit at a certain time interval when the motion detection unit does not detect the motion equal to or greater than the predetermined value for no less than a fixed period of time. Here, the control unit causes the display unit to display from among the image data pieces stored in the 2nd buffer, a most recently stored piece.

With such a structure in which the 1st and 2nd buffers are provided, the present invention is capable of reducing the total amount of stored data and providing image data corresponding to holding down the shutter button.

The digital still camera may further comprise: an image data storage unit operable to store image data pieces. Here, when the detection unit detects the operation of holding down the shutter button, the control unit reads the most recently stored piece displayed by the display unit and causes the image data storage unit to store therein the read most recently stored piece.

With such a structure, the present invention is capable of storing blurring-free image data corresponding to holding down the shutter button.

The motion detection unit may be composed of one of an angular velocity sensor and a three-dimensional velocity sensor.

With such a structure, the present invention is capable of detecting the motion of the body of the digital still camera with precision.

The above-stated object is also achieved by a mobile phone comprising the digital still camera.

With such a structure, the present invention is capable of loading the digital still camera, able to handle hand shake with a simple mechanism, into a mobile phone.

The above-stated object is also achieved by an image stabilizing method of a digital still camera comprises the steps of: an operation step of receiving operations from the user; a detection step of detecting the operations; an image capture step of capturing image data pieces of a subject at a predetermined time interval when a predefined operation is detected in the detection step; a storing step of storing, in a storage area, the image data pieces captured in the image capture step in order of being captured; a display step of displaying the image data pieces stored in the storage area; and a control step of causing, from among the image data pieces stored in the storage area, a most recently stored piece to be displayed in the display step when an operation of holding down a shutter button is detected in the detection step.

With such a method, the present invention is capable of displaying a clear and sharp image free from blurring even if hand shake is made when the user holds down the shutter button.

### BRIEF DESCRIPTION OF THE DRAWINGS

These and other objects, advantages and features of the invention will become apparent from the following description thereof taken in conjunction with the accompanying drawings which illustrate specific embodiments of the invention. In the drawings:

FIG. 1 shows a structure of Embodiment 1 of a digital still camera of the present invention;

FIG. 2 shows appearance of the digital still camera of Embodiment 1;

FIG. 3 is an explanatory diagram of image data stored in a buffer of Embodiment 1;

FIG. 4 is a flowchart describing operation according to Embodiment 1;

FIG. 5 shows a structure of Embodiment 2 of a digital still camera of the present invention;

FIG. 6 illustrates shutter operation and image data stored according to Embodiment 2;

FIG. 7 is a flowchart, part 1, illustrating operation according to Embodiment 2; and

FIG. 8 is a flowchart, part 2, illustrating operation according to Embodiment 2.

### DESCRIPTION OF THE PREFERRED EMBODIMENTS

Next are described embodiments of a digital still camera according to the present invention with the aid of drawings.

### 1. Embodiment 1

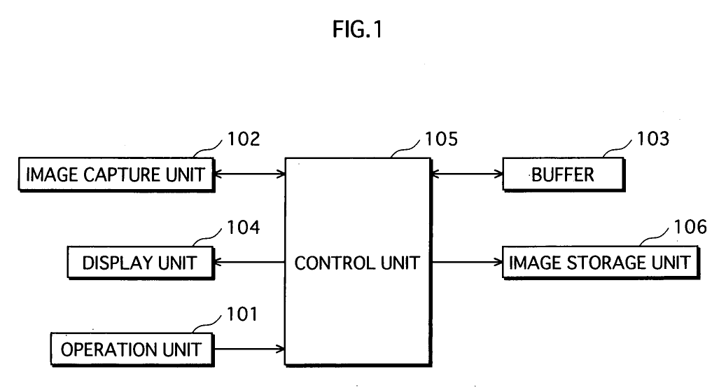

FIG. 1 shows a structure of Embodiment 1 of the digital still camera according to the present invention.

The digital still camera comprises: an operation unit 101; an image capture unit 102; a buffer 103; a display unit 104; a control unit 105; and an image storage unit 106.

The operation unit 101 receives user operation and sends a signal indicating the operation to the control unit 105.

The image capture unit 102 comprises a lens and an image capture device, such as CCD, CMOS or the like. The image capture unit 102 captures an image of a subject and outputs the image data to the control unit 105 according to the direction of the control unit 105.

The buffer 103 is composed of RAM and the like. Image data input to the control unit 105 from the image capture unit 102 is compressed by the control unit 105 and then stored in the buffer 103.

The display unit 104 is composed of a liquid crystal display and the like. Image data stored in the buffer 103 is read by the control unit 105, and the image is then displayed in the display unit 104.

The control unit 105 has a CPU, and controls each unit of the digital still camera according to a control program stored in ROM. The control unit 105 receives power supply on a steady basis, even before the power supply of the body of the digital still camera is turned on.

When receiving a signal indicating auto focus operation after the power supply is turned on in the operation unit 101, the control unit 105 resets its own timer, and directs the image capture unit 102 to capture an image of a subject. The control unit 105 starts the timer with the direction of capturing an image, and directs the image capture unit 102 to capture an image of the subject at a predetermined time interval t-for example, every 100 ms, until receiving a signal indicating the shutter button being held down.

The minimum of the predetermined time interval t is defined as the sum of the time required to store image data captured by the image capture unit 102 in the buffer 103 and the time required to read the image data stored in the buffer 103 and display the image in the display unit 104.

When receiving an input of image data from the image capture unit 102, the control unit 105 compresses the image data according to JPEG standards for example; stores the compressed image data in the buffer 103; reads the stored image data; and displays the image in the display unit 104.

When receiving a signal indicating the shutter button being held down from the operation unit 101, the control unit 105 reads image data stored most recently in the buffer 103, and stores the image data in the image storage unit 106 at the same time as displaying the image in the display unit 104.

If receiving a signal indicating the shutter button being held down from the operation unit 101 without having received a signal indicating auto focus operation, the control unit 105 directs the image capture unit 102 to capture an image of a subject.

When receiving an input of image data from the image capture unit 102, the control unit 105 compresses the image data according to JPEG standards, and displays the image in the display unit 104 as well as storing the image data in the image storage unit 106.

The image storage unit 106 comprises a flash memory, such as a memory card. Image data corresponding to holding down the shutter button is stored by the control unit 105, and the image storage unit 106 stores the image data.

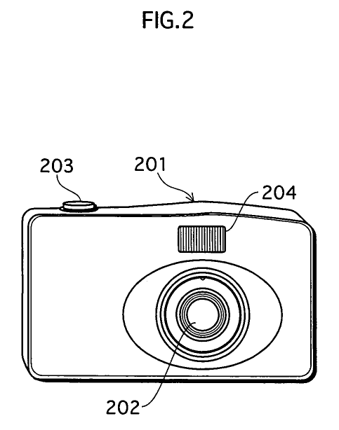

FIG. 2 shows appearance of the digital still camera viewed from an anterior perspective. At the front of a body 201, a lens 202 constituting the image capture unit 102 is positioned. Equipped on the upper side of the lens 202 is a flash 204. In addition, a shutter 203 constituting the operation unit 101 is provided on the top face of the body 201. When the shutter 203 is held down halfway, a signal indicating auto focus operation is sent to the control unit 105.

At the back side of the body 201, a power button and the display unit 104 are provided.

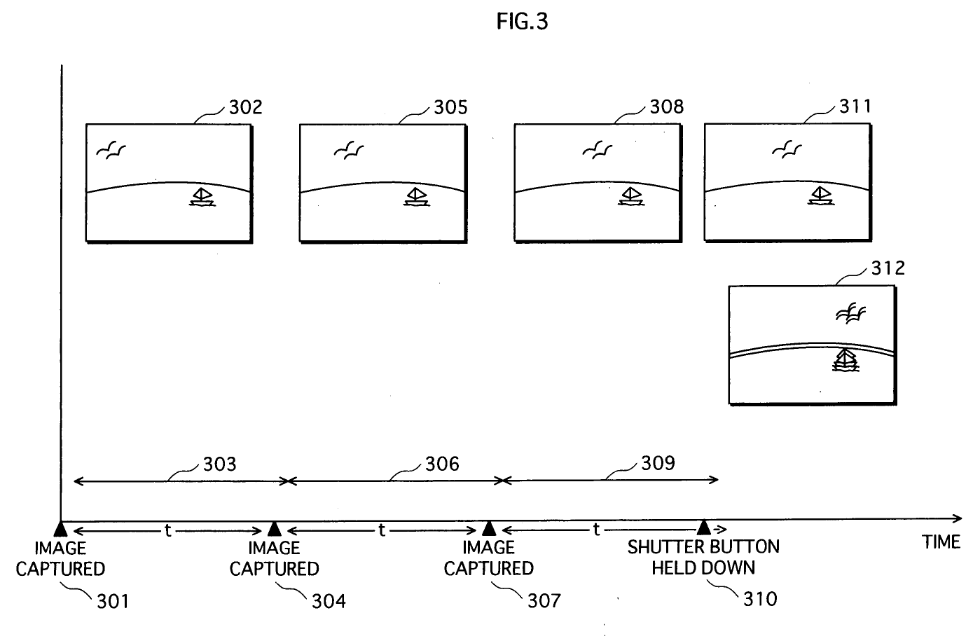

FIG. 3 is a diagram for explaining image data stored in the image storage unit 106 at the time when operation of the shutter button being held down is performed after auto focus operation.

The horizontal axis in FIG. 3 is time. Images of a subject are captured at the predetermined time interval t from a time point 301 when auto focus operation is performed. Captured images are shown on the upper side of the figure. An image 302 captured at the time point 301 is displayed in the display unit 104 for the period of time indicated by an arrow 303. Similarly, an image 305 captured at a time point 304 is displayed in the display unit 104 for the period of time indicated by an arrow 306. An image 308 captured at a time point 307 is displayed in the display unit 104.

When operation of the shutter button being held down is performed at a time point 310 which is within the predetermined time interval t from the time point 307, an image being displayed in the display unit 104—that is, image data stored most recently in the buffer 103—is read by the control unit 105, and an image 311 is redisplayed in the display unit 104 after the period of time indicated by an arrow 309 which is shorter than the predetermined time interval t.

Here, when no auto focus operation is performed, an image 312 with blurring, as shown on the lower side of FIG. 3, due to hand shake associated with holding down the shutter button is displayed in the display unit 104.

Note that focusing the lens 202 on a subject using auto focus operation and the like are well known technologies, and therefore, those descriptions are omitted here.

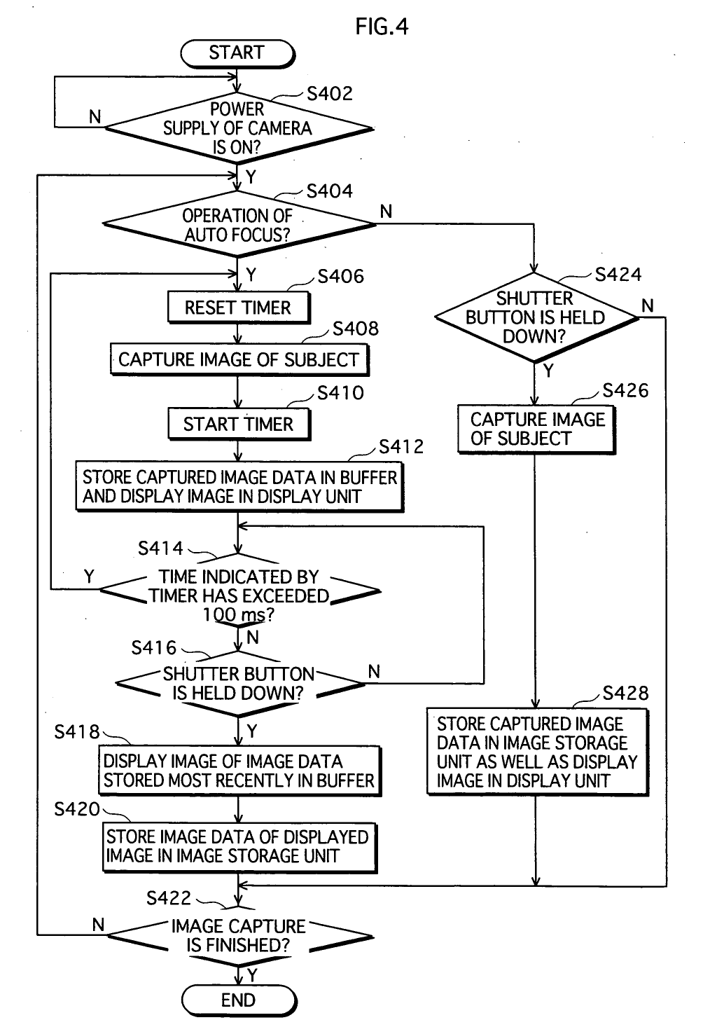

Next is described operation of the present embodiment with the aid of a flowchart shown in FIG. 4.

First, the control unit 105 waits for turning-on operation of the power supply from the operation unit 101 (Step S402), and then, judges whether to have received a signal of auto focus operation (Step S404). When having received a signal of auto focus operation, the control unit 105 resets the timer (Step S406), and directs the image capture unit 102 to capture an image of a subject.

The image capture unit 102 captures an image of the subject, and outputs the captured image data to the control unit 105 (Step S408)

The control unit 105 starts the timer (Step S410), and has the buffer 103 store the input image data therein while having the display unit 104 display the image (Step S412).

The control unit 105 judges whether the time indicated by the timer has exceeded 100 ms (Step S414). Here, if NO, the control unit 105 further judges whether to have received a signal of holding down the shutter button from the operation unit 101 (Step S416). If NO, the process returns to Step S414. At Step S414, the process returns to Step S406 if the time indicated by the timer has exceeded 100 ms.

At Step S416, when having received a signal of holding down the shutter button, the control unit 105 reads image data stored most recently in the buffer 103, and displays the image in the display unit 104 (Step S418). Then, the control unit 105 stores image data of the displayed image in the image storage unit 106 (Step S420).

The control unit 105 judges whether the image capture is finished according to the power supply being turned off (Step S422). If YES, the process is terminated, while the process returns to Step S404 if NO.

When determining not to have received auto focus operation at Step S404, the control unit 105 further judges whether to have received a signal of holding down the shutter button (Step S424). Then, when YES, the control unit 105 directs the image capture unit 102 to capture an image. If NO, the process moves to Step S422.

The image capture unit 102 captures an image of the subject, and outputs the image data to the control unit 105 (Step S426).

The control unit 105 displays, in the display unit 104, the image data input from the image capture unit 102 while at the same time storing this in the image storage unit 106 (Step S428), and the process then moves to Step S422.

The present embodiment assumes that beginners in handling a camera experience hand shake at the time of holding down the shutter button. In the present embodiment, image data captured right before the shutter button is held down is stored, and this stored image data is used as a replacement of blurry image data captured when the shutter button is held down with hand shake.

### 2. Embodiment 2

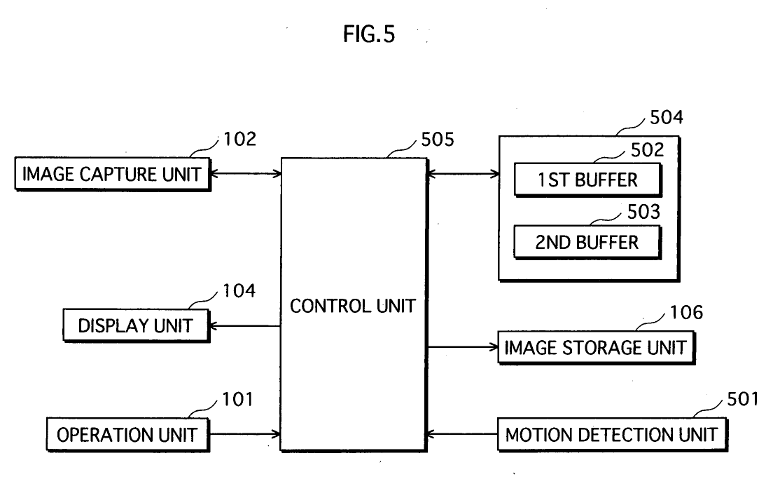

FIG. 5 shows a structure of Embodiment 2 of the digital still camera according to the present invention. The digital still camera comprises a motion detection unit 501 in addition to the components of the digital still camera of Embodiment 1 above. Additionally, the digital still camera of the present embodiment has, in place of the buffer 103, a buffer 504 comprising a 1st buffer 502 and a 2nd buffer 503, and has a control unit 505 in place of the control unit 105. The same components as those in Embodiment 1 above have the same numerals, and their descriptions are left out here.

The motion detection unit 501 is implemented with a gyro sensor built into a body of the digital still camera, and detects the angular velocity of the digital still camera. Note that, instead of the angular velocity, the velocity of the camera body may be detected by using a three-dimensional velocity sensor, or alternatively, the acceleration of the camera body may be detected by an angular acceleration sensor or an acceleration sensor.

The motion detection unit 501 notifies the control unit 505 of the detected angular velocity that represents the motion of the digital still camera.

The buffer 504 comprises the 1st buffer 502 for image display and the 2nd buffer 503 for temporary storage. Both of the 1st and 2nd buffers 502 and 503 are composed of, for example, RAM.

The 1st buffer 502 has a storage area for at least two frames of image data. The 1st buffer 502 stores image data that has been captured by the image capture unit 102 and then compressed by the control unit 505 according to JPEG standards in order to display an image of the captured image data in the display unit 104. The 1st buffer 502 stores image data captured by the image capture unit 102 alternatively in one of the two regions of the storage area, updating previously stored image data therein. Accordingly, image data stored most recently is stored in either one of the regions.

The 2nd buffer 503 has a storage area for at least one frame of image data. The 2nd buffer 503 stores image data captured by the image capture unit 102 at a predetermined time interval (e.g. at an interval of 300 ms) when the control unit 505 is receiving a notice of a detection value less than a threshold (e.g. 1 degree/sec) from the motion detection unit 501 over a predefined period of time (e.g. 500 ms). When a detection value equal to or greater than the threshold is detected by the motion detection unit 501 at the time when the shutter button is held down, image data stored in the 2nd buffer 503 is stored in the image storage unit 106 as image data corresponding to the hold down of the shutter button.

The control unit 505 has timers and counters. The control unit 505 has received power supply in advance, and directs the image capture unit 102 to capture images of a subject at a predetermined time interval upon receiving turning-on operation of the power supply from the operation unit 101. The predetermined time interval is the same as in the case of Embodiment 1 above. When receiving an input of image data from the image capture unit 102, the control unit 505 stores the image data in one of the two regions of the 1st buffer 502. The control unit 505 displays an image of the stored image data in the display unit 104. Then, next time when receiving an input of image data from the image capture unit 102, the control unit 505 stores the image data in the other region of the 1st buffer 502. The control unit 505 stores the input image data alternately in the two regions of the 1st buffer 502, overwriting previously stored image data therein.

A 1st timer and a 1st counter are used for measuring the predefined period of time and for directing the image capture unit 102 to capture an image.

Upon receiving a notice of the angular velocity detected by the motion detection unit 501, the control unit 505 compares the angular velocity and a threshold (e.g. 1 degree/sec) that is a predetermined value stored in itself. When the informed angular velocity is less than the threshold, the control unit 505 determines that the digital still camera has not moved. On the other hand, when the informed angular velocity is equal to or greater than the threshold, the control unit 505 determines that the digital still camera has moved. Note that the threshold of the predetermined value is a value at which an image captured by the image capture unit 102 gets blurred due to hand shake.

When determining that the digital still camera has not moved over a fixed time period (e.g. 500 ms) from the start of image capturing, the control unit 505 stores image data input from the image capture unit 102 in the 2nd buffer 503 at a certain interval-for example, every three frames (image data), updating the 2nd buffer 503.

The control unit 505 displays, in the display unit 104, image data stored in the 2nd buffer 503. In addition, image data not stored in the 2nd buffer 503 is stored in the 1st buffer 502.

The control unit 505 uses a 2nd timer and a 2nd counter for storing image data in the 2nd buffer 503.

Note that, when the angular velocity informed from the motion detection unit 501 for the above-mentioned fixed time period is equal to or greater than the threshold, the control unit 505 resets the 1st timer, and measures the fixed time period of 500 ms from the beginning. The fixed time period is defined on the assumption that the lens 202 is pointed at a subject and the digital still camera is not moved for a brief period.

Also when receiving a signal indicating the shutter button being held down from the operation unit 101, the control unit 505 displays, in the display unit 104, an image of the latest image data stored in the 1st buffer 502 until the above-mentioned fixed time period elapses, as well as storing the image data in the image storage unit 106.

In the case where the angular velocity informed from the motion detection unit 501 is less than the predetermined value over a fixed time period and the control unit 505 then receives a signal indicating the shutter button being held down from the operation unit 101, the control unit 505 reads image data stored in the 2nd buffer 503, and stores the image data in the image storage unit 106 while displaying an image of the image data in the display unit 104.

Note that, at the time when the control unit 505 receives a signal of holding down the shutter button, if the angular velocity informed from the motion detection unit 501 is less than the predetermined value, the control unit 505 then stores, in the image storage unit 106, image data captured in sync with the shutter button being held down, while displaying an image of the captured image data in the display unit 104.

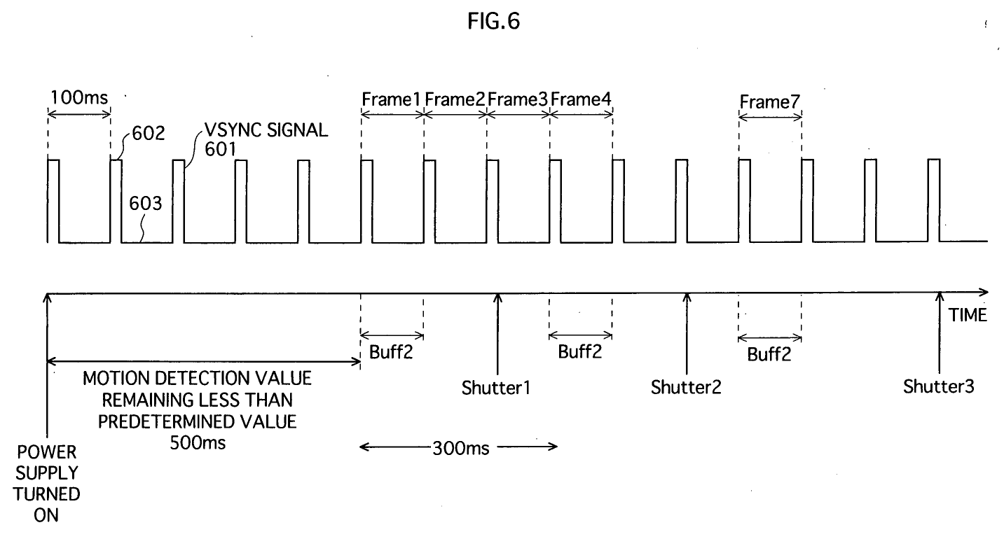

FIG. 6 illustrates user's operation of holding down the shutter button together with image data stored in the image storage unit 106.

The horizontal axis in FIG. 6 is time. A VSYNC signal 601 fulfilling the same function as a timer is output with a period of 100 ms. When the VSYNC signal 601 is in high level state 602, the control unit 505 directs the image capture unit 102 to capture an image; receives an input of the image data from the image capture unit 102; and stores the image data in the 1st buffer 502 or the 2nd buffer 503. When the VSYNC signal 601 is in low level state 603, the control unit 505 reads an image from the 1st or 2nd buffer 502 or 503, and displays the image in the display unit 104.

After the motion detection value informed from the motion detection unit 501 remains less than the predetermined value for a fixed time period of 500 ms, the control unit 505 stores one every three frames of image data (Frame1, Frame 2, . . . , and Frame7 in the figure) output from the image capture unit 102 in the 2nd buffer (Buff2 in the figure).

When the control unit 505 has received a signal of holding down the shutter button from the operating unit 101, if the motion detection value informed from the motion detection unit 501 is equal to or greater than the predetermined value, the control unit 505 displays respectively, in the display unit 104, Frame 1 in the case when Shutter1 is held down, Frame 4 when Shutter 2 is held down, and Frame 7 when Shutter 3 is held down. At the same time, the control unit 505 stores each image data frame in the image storage unit 106.

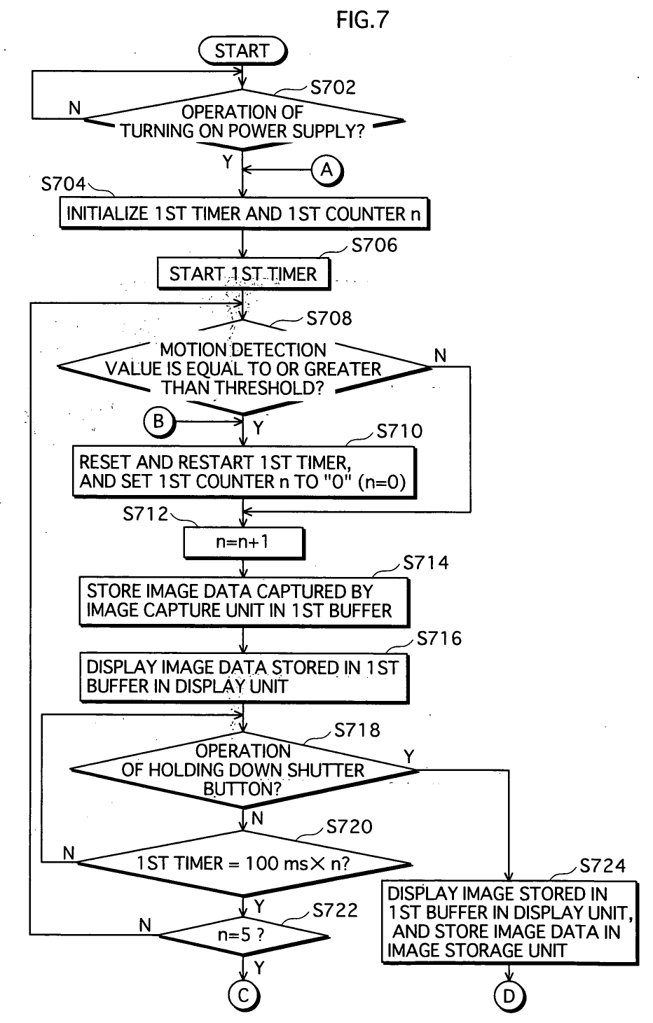

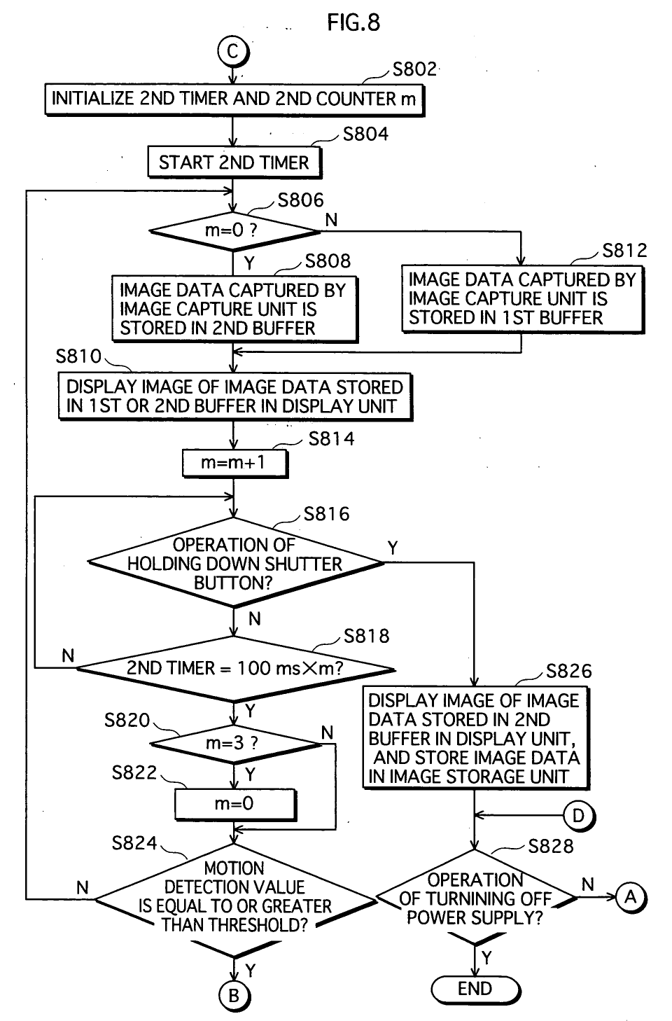

Next is described operation of the present embodiment with the aid of flowcharts shown in FIGS. 7 and 8.

First, the control unit 505 waits for turning-on operation of the power supply (Step S702), and then initializes the 1st timer and resets the 1st counter n to “0” (Step S704). Next, the control unit 505 directs the image capture unit 102 to capture an image, and starts the 1st timer (Step S706). Then, the control unit 505 judges whether a detection value informed from the motion detection unit 501 is equal to or greater than a threshold (Step S708). If YES, the control unit 505 determines that the body of the digital still camera has moved, and restarts the 1st timer after resetting it while setting the 1st counter n to “0” (Step S710), before the process moves to Step S712. If NO, the control unit 505 adds “1” to the counter n (Step S712).

The control unit 505 receives an input of image data captured by the image capture unit 102; stores the image data in the 1st buffer (Step S714); and displays an image of the stored image data in the display unit 104 (Step S716).

Next, the control unit 505 judges whether to have received a signal indicating the shutter button being held down from the operation unit 101 (Step S718). If YES, the control unit 505 displays an image of the image data stored in the 1st buffer in the display unit 104, and stores the image data in the image storage unit 106 (Step S724) before the process moves to Step S828. If there is no operation of holding down the shutter button, the control unit 505 judges whether the value indicated by the 1st timer is 100 ms×n (Step S720). Here, if NO, the process returns to Step S718. If YES, the control unit 505 further judges whether the 1st counter n is “5” (Step S722). Here, if NO, the process returns to Step S708. If YES, the control unit 505 initializes the 2nd timer and the 2nd counter m (Step S802). Subsequently, the control unit 505 starts the 2nd timer (Step S804), and judges whether the 2nd counter m is “0” (Step S806). Here, if YES, the control unit 505 directs the image capture unit 102 to capture an image of a subject.

The image capture unit 102 captures an image of the subject, and outputs the image data to the control unit 505. The control unit 505 stores the input image data in the 2nd buffer 503 (Step S808). The control unit 505 reads image data stored in the 1st or 2nd buffer 502 or 503, and displays the read image in the display unit 104 (Step S810). When determining that the 2nd counter m is not “0” at Step S806, the control unit 505 directs the image capture unit 102 to capture an image, and stores image data input from the image capture unit 102 (Step S812) before the process moves to Step S810.

Next, the control unit 505 adds “1” to the 2nd counter m (Step S814), and judges whether there is operation of holding down the shutter button (Step S816).

Here, if NO, the control unit 505 further judges whether the value indicated by the 2nd timer is 100 ms×m (Step S818). Here, if NO, the process returns to Step S816. If YES, the control unit 505 further judges whether the value of the 2nd counter m is “3” (Step S820). Here, if YES, the control unit 505 sets the 2nd counter m to “0” (Step S822), and judges whether the motion detection value informed from the motion detection unit 501 is equal to or greater than the threshold (Step S824). Here, the process returns to Step S710 if YES while returning to S806 if NO.

If YES at Step S816, the control unit 505 reads image data stored most recently in the 2nd buffer, and displays the image in the display unit 104 while storing the image data in the image storage unit 106 (Step S826). Then, the control unit 505 judges whether there is operation of turning off the power supply (Step S828). Here, if YES, the control unit 505 terminates the process, while the process returns to Step S704 when NO.

The motion detection unit 501 is implemented by using a detection sensor such as an angular velocity sensor in the present embodiment. However, it is a matter of course that software for detecting motion through image recognition can be used instead.

In addition, the prevention of hand shake of the digital still camera described in the above embodiments can be realized with a simple mechanism, and therefore, the mechanism can be built in a mobile phone.

Because allowing the prevention of hand shake with a simple mechanism, the digital still camera according to the present invention can be employed in the camera industry as a digital still camera achieving the prevention of hand shake at a low price.

Although the present invention has been fully described by way of examples with reference to the accompanying drawings, it is to be noted that various changes and modifications will be apparent to those skilled in the art. Therefore, unless such changes and modifications depart from the scope of the present invention, they should be constructed as being included therein.

What is claimed is:

1. A digital still camera comprising:
an operation unit operable to receive operations from a user;
a detection unit operable to detect the operations;
an image capture unit operable to capture image data pieces of a subject at a predetermined time interval when the detection unit detects a predefined operation;
a buffer operable to store therein the image data pieces captured by the image capture unit in order of being captured;
a display unit operable to display the image data pieces stored in the buffer; and
a control unit operable to cause the display unit to display, from among the image data pieces stored in the buffer, a most recently stored piece when the detection unit detects an operation of holding down a shutter button.

2. The digital still camera of claim 1, wherein a minimum length of the predetermined time interval is defined as a sum of (i) time required to store each piece of the image data pieces captured by the image capture unit into the buffer and (ii) time required to read the piece from the buffer and display the read piece in the display unit.

3. The digital still camera of claim 2, further comprising:
an image data storage unit operable to store therein image data pieces, wherein
the predefined operation is to set for auto focus mode, and
when the detection unit detects the operation of holding down the shutter button, the control unit reads the most recently stored piece displayed by the display unit and causes the image data storage unit to store therein the read most recently stored piece.

4. The digital still camera of claim 2, further comprising:
a motion detection unit operable to detect a motion of a body of the digital still camera, wherein
the predefined operation is to turn on a power supply for starting to capture the image data pieces, and
if the motion detection unit detects the motion which is equal to or greater than a predetermined value at a moment when the detection unit receiving power supply in advance detects the operation of holding down the shutter button, the control unit causes the display unit to display the most recently stored piece.

5. The digital still camera of claim 4, wherein
the predetermined value is a value at which the image data pieces captured by the image capture unit become blurred from movements of the digital still camera due to hand shake.

6. The digital still camera of claim 5, wherein the buffer includes:
a 1st buffer used by the control unit to store therein the image data pieces captured by the image capture unit while sequentially updating; and
a 2nd buffer used by the control unit, instead of the 1st buffer, to store therein the image data pieces captured by the image capture unit at a certain time interval when the motion detection unit does not detect the motion equal to or greater than the predetermined value for no less than a fixed period of time, wherein
the control unit causes the display unit to display, from among the image data pieces stored in the 2nd buffer, a most recently stored piece.

7. The digital still camera of claim 6, further comprising:
an image data storage unit operable to store image data pieces, wherein
when the detection unit detects the operation of holding down the shutter button, the control unit reads the most recently stored piece displayed by the display unit and causes the image data storage unit to store therein the read most recently stored piece.

8. The digital still camera of claim 7, wherein
the motion detection unit is composed of one of an angular velocity sensor and a three-dimensional velocity sensor.

9. A mobile phone comprising the digital still camera of claim 1 is built.

10. An image stabilizing method of a digital still camera comprises the steps of:
an operation step of receiving operations from a user;
a detection step of detecting the operations;
an image capture step of capturing image data pieces of a subject at a predetermined time interval when a predefined operation is detected in the detection step;
a storing step of storing, in a storage area, the image data pieces captured in the image capture step in order of being captured;
a display step of displaying the image data pieces stored in the storage area; and
a control step of causing, from among the image data pieces stored in the storage area, a most recently stored piece to be displayed in the display step when an operation of holding down a shutter button is detected in the detection step.
